(19) United States
(12) Patent Application Publication
(10) Pub. No.: US 2019/0130526 A1
(43) Pub. Date: May 2, 2019

(54) METADATA BASED QUALITY ENHANCEMENT POST-VIDEO WARPING

(71) Applicant: Avago Technologies General IP (Singapore) Pte. Ltd., Singapore (SG)

(72) Inventors: Minhua ZHOU, San Diego, CA (US); David WU, San Diego, CA (US); Xuemin CHEN, Rancho Santa Fe, CA (US)

(21) Appl. No.: 15/796,654

(22) Filed: Oct. 27, 2017

(51) Int. Cl. G06T 3/00; H04N 13/00; H04N 13/04

(52) U.S. Cl. CPC G06T 3/0093; H04N 13/044; H04N 13/0018

(57) ABSTRACT

In the subject system for video warping, an electronic device may receive video data (e.g., from a video source). The electronic device may also receive or generate control information including view configuration information (e.g., for one or more viewports). The electronic device may warp a subset of the video data according to the view configuration information. The electronic device may process the warped subset of the video data using metadata associated with the video data. The electronic device may provide, for display, the processed subset of the video data. By warping the subset of the video data and then processing the warped subset of the video data, the system performs processing on the subset of the video data, instead of performing the processing the entire video data. In addition, the warped video data may be at a lower resolution than the original video data, which may require less resources for processing.

### TECHNICAL FIELD

The present description relates generally to a video warping system, including a video warping system in which metadata based quality enhancement is performed after video warping.

### BACKGROUND

In video applications, when video data is received to be displayed, the video data is decoded and processed for a display device. Metadata may be provided with video data such that the video data may be processed using information in the metadata to enhance video quality for a particular display device. Further, additional processing on the video data may be performed without using the metadata.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which metadata based quality enhancement post-video warping may be implemented in accordance with one or more implementations.

FIG. 2 illustrates an example electronic device that may implement metadata based quality enhancement post-video warping in accordance with one or more implementations.

FIGS. 3A and 3B illustrate diagrams of example device architectures for metadata based quality enhancement post-video warping in accordance with one or more implementations.

FIG. 4A is an example diagram illustrating video data at various stages of the example process of FIG. 3A or the example device architecture of FIG. 3B in accordance with one or more implementations.

FIG. 4B is an example diagram illustrating video data at various stages of the example process of FIG. 3A or the example device architecture of FIG. 3B in accordance with one or more implementations.

FIGS. 5A and 5B illustrate diagrams of example device architectures for metadata based quality enhancement post video-warping in accordance with one or more implementations.

FIG. 6A is an example diagram illustrating video data at various stages of the example process of FIG. 5A or the example device architecture of FIG. 5B in accordance with one or more implementations.

FIG. 6B is an example diagram illustrating video data at various stages of the example process of FIG. 5A or the example device architecture 550 of FIG. 5B in accordance with one or more implementations.

FIGS. 7-9 illustrate a flow diagram of example processes of metadata based quality enhancement post-video warping in accordance with one or more implementations.

FIG. 10 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more implementations. In one or more implementations, structures and components are shown in block diagram form in order to avoid obscuring the concepts of the subject technology.

In a video processing system, when video data is received from a video source, the video data may undergo decoding and processing, as well as, in some instances, video warping. In particular, a video decoder of the video processing system may decode received video data from a video source (e.g., a server, a storage media, etc.). The video processing system may extract metadata (e.g. high dynamic range (HDR) metadata, film grain metadata) from the video data (e.g., by the video decoder) and/or metadata may be received by other means such as from a High-Definition Multimedia Interface (HDMI) connection with a display device. HDR metadata may include source a video resolution, frame rate, primary color space, an electro-optical transfer function (EOTF) function type, a maximum luminance level, a minimum luminance level, and an average luminance level. The film grain metadata may include information required to simulate the original film grain on the receiver side, such as a film grain model and a blending type, color description, a luminance intensity range, film grain intensity, a film grain size, and etc. The decoded video data is enhanced by using a video quality enhancement component that processes the decoded video data using the received metadata and display information corresponding to the display device (e.g., display resolution, frame-rate, dynamic range, Electro-Optical Transfer Function (EOTF) function type etc.). In this manner, the characteristics of the enhanced video data may match the characteristics of the display device.

The metadata based video quality enhancement is generally performed on the entire video data (e.g., in a full original resolution of the received video data). The processing of the entire video data in the full original resolution may consume a large amount of computational and/or power resources, and may utilize high read/write memory bandwidth (e.g., to read video data from the memory buffer for processing and to write the enhanced video data back to the memory buffer). The processing of the entire video data may be even more challenging when a size of the video data is large and/or the resolution of the video data is high. However, when video warping is applied, a subset of the video data that corresponds to one or more viewports currently in use, such as the portion(s) of a 360 video being viewed, may be extracted and warped which may result in subset of the video data being in a lower resolution than the original video data. Thus, when video warping is being applied, it may not be desirable to perform the metadata based video quality enhancement on the entirety of the video data at the original resolution, since the resolution of the warped video data will be lower than the original resolution and only a portion of the video data will be provided for display to the user.

In the subject system for metadata based quality enhancement post-video warping, video warping may be performed on a subset of received video data corresponding to one or more viewports currently in use. After the subset of the received video data has been warped, the metadata based video quality enhancement may be performed on the warped video data, which may only include the subset of the received video data that may be at a lower resolution than the received video data. Thus, the subject system may reduce the memory and/or computational resources and/or power consumption for the video processing, and may also reduce read/write memory bandwidth for the video processing, by performing the metadata based quality enhancement on the warped video data, e.g. post-video warping, instead of the entire video data.

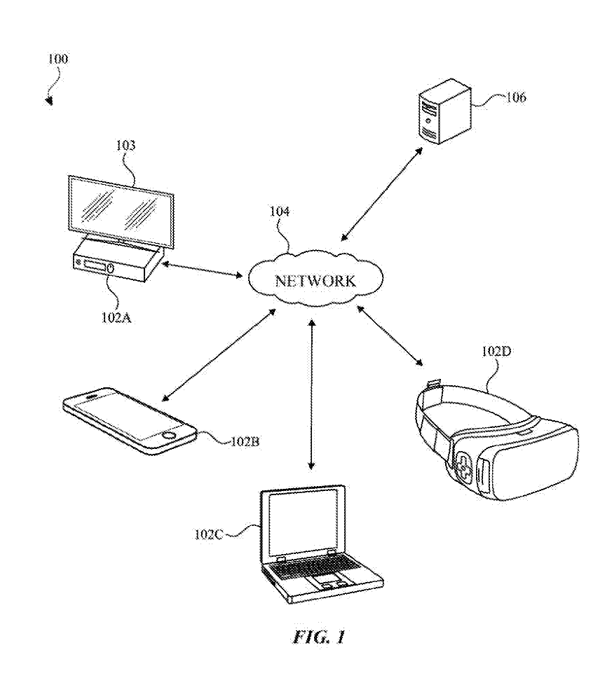

FIG. 1 illustrates an example network environment 100 in which metadata based quality enhancement post-video warping may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes one or more electronic devices 102A-D and a server 106. The electronic devices 102A-D as well as the server 106 may be connected to a network 104, such that the electronic devices 102A-D may be able to receive video data from the server 106 via the network 104. In one or more implementations, one or more of the electronic devices 102A-D may receive video data from a storage unit, where the storage unit may be a local storage unit or an external storage device. The electronic devices 102A-D, and/or the server 106, may be, and/or may include all or part of, the electronic system discussed below with respect to FIG. 10. The electronic devices 102A-D are presented as examples, and in other implementations, other devices may be substituted for one or more of the electronic devices 102A-D.

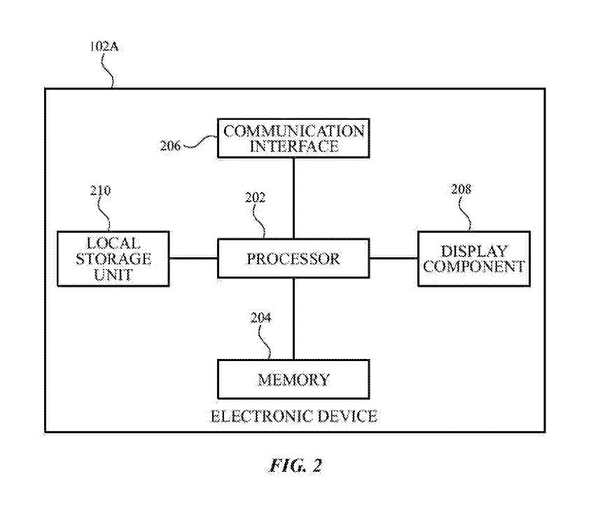

The electronic devices 102A-D may be devices capable of processing video data and displaying the processed video data, or providing the processed video data for display. One or more of the electronic devices 102A-D may include, or may be communicatively coupled to, a display device to display the processed video data. For example, the electronic devices 102A-D may be portable computing devices such as laptop computers, smartphones, peripheral devices (e.g., digital cameras, monitors), tablet devices, wearable devices (e.g., a display headset, etc.), stationary devices (e.g. set-top-boxes), or other appropriate devices that include one or more video processing resources. In FIG. 1, by way of example, the electronic device 102A is depicted as a set-top-box which is connected to a display device 103 (e.g. TV), the electronic device 102B is depicted as a mobile device, the electronic device 102C is depicted as a laptop computer, and the electronic device 102D is depicted as a display headset. One or more of the electronic devices 102A-D may be, and/or may include all or part of, the electronic device discussed below with respect to FIG. 2 and/or the electronic system discussed below with respect to FIG. 10.

One or more of the electronic devices 102A-D, such as the electronic device 102A, may include and/or may implement a video warping system to warp a subset of video data received at the electronic device 102A. As discussed above, processing the entire video data (e.g., using metadata) is costly, consuming a large amount of computation resources and power and high read/write memory bandwidth. Therefore, if a subset of the video data will be used for display instead of using the entire video data, processing the entire video data in a full original resolution may not desirable. Instead of processing the entire video data, processing the subset of the video data after video warping may be an efficient use of the computation resources and read/write memory bandwidth. Hence, according to the subject system, when the electronic device 102A receives and decodes video data, the electronic device 102A warps a subset of the decoded video data and subsequently processes the warped subset of the decoded video data, instead of processing the entire video data.

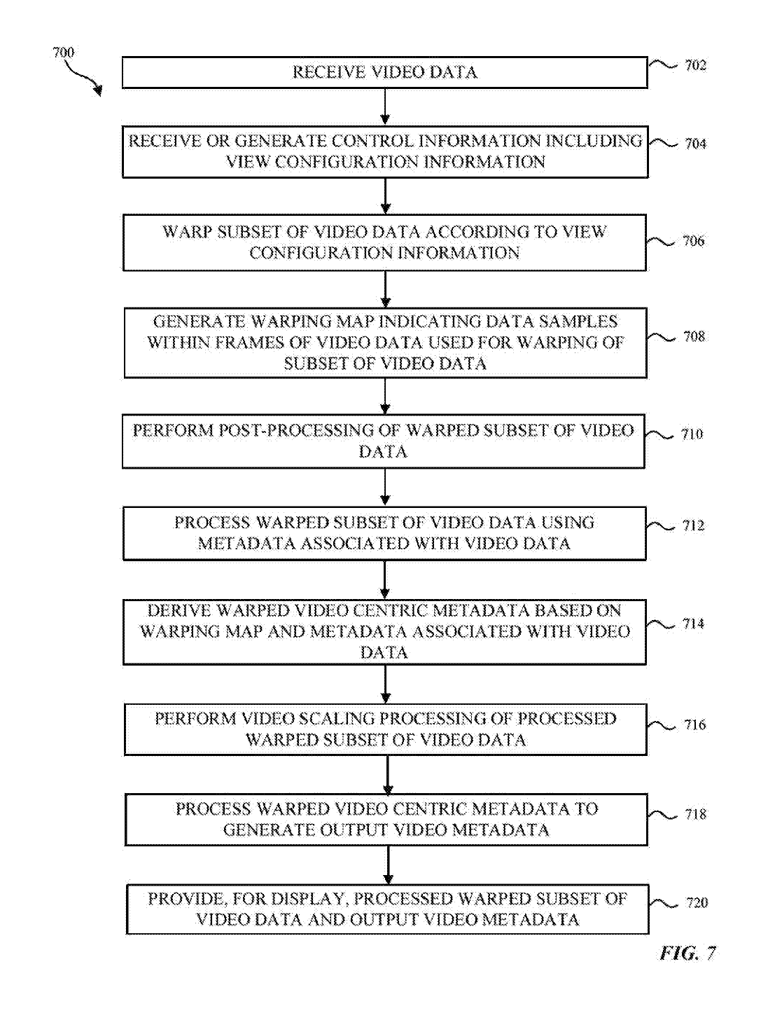

The electronic device 102A may implement the subject video warping system to mitigate/reduce any detrimental impact, such as excessive processing/memory/power consumption, when the electronic device 102A processes the video data. The same or similar implementation of the subject video warping system may be applied to one or more of the electronic devices 102B, 102C and 102D. The subject system may allow the electronic device 102A to prevent excessive use of the computation resources and the read/write memory bandwidth, thereby providing an efficient approach to process the video data. An example electronic device 102A implementing the subject system is discussed further below with respect to FIG. 2, and example processes of an electronic device 102A implementing the subject system are discussed further below with respect to FIGS. 7-9.

FIG. 2 illustrates an example electronic device 102A that may implement metadata based quality enhancement post-video warping in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 102A may include, among other components, a processor 202, a memory 204, and a communication interface 206. The processor 202 of the electronic device 102A may be communicatively coupled to a display component 208, where the display component 208 may be a part of the electronic device 102A or may be a separate device. Optionally, the electronic device 102A may include a local storage unit 210 from which video data may be received. The processor 202, which may also be referred to as an application processor or a control processor, may include suitable logic, circuitry, and/or code that enable processing data and/or controlling operations of the electronic device 102A. In this regard, the processor 202 may be enabled to provide control signals to various other components of the electronic device 102A.

The processor 202 may also control transfers of data between various portions of the electronic device 102A. Additionally, the processor 202 may enable implementation of an operating system or otherwise execute code to manage operations of the electronic device 102A. The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage. The memory 204 may also include, for example, dynamic random-access memory (DRAM) that may be used as a buffer during video processing.

The communication interface 206 may be used by the processor 202 to communicate via a network communication protocol, such as cables (e.g., an HDMI cable), Wi-Fi, cellular, Ethernet, Bluetooth, BTLE, Zigbee, NFC, or the like. In one or more implementations, the communication interface 206 may be, may include, and/or may be communicatively coupled to a radio frequency (RF) circuit, such as a Bluetooth circuit and/or an NFC circuit may be, may include, and/or may be communicatively coupled to a second RF circuit, such as a WLAN circuit, a cellular RF circuit, or the like.

The processor 202 may receive video data via various means. In one example, the processor 202 may use the communication interface 206 to receive video data from the server 106 via the network 104. In another example, the processor 202 may receive video data from the local storage unit 210 within the electronic device 102A.

In one or more implementations, one or more of the processor 202, the memory 204, the communication interface 206, and/or one or more portions thereof, may be implemented in software (e.g., subroutines and code), hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

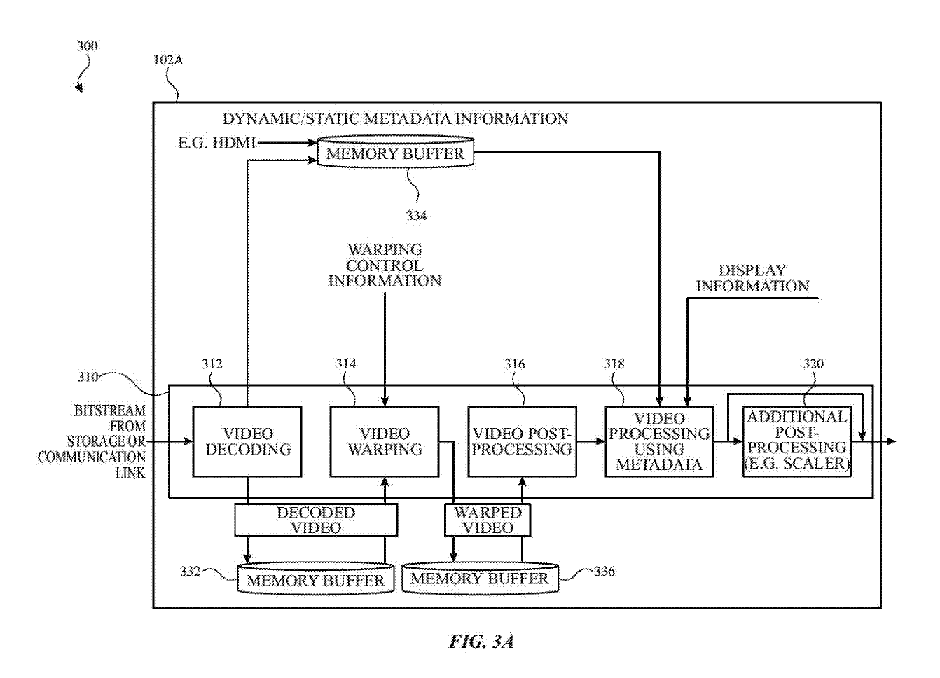

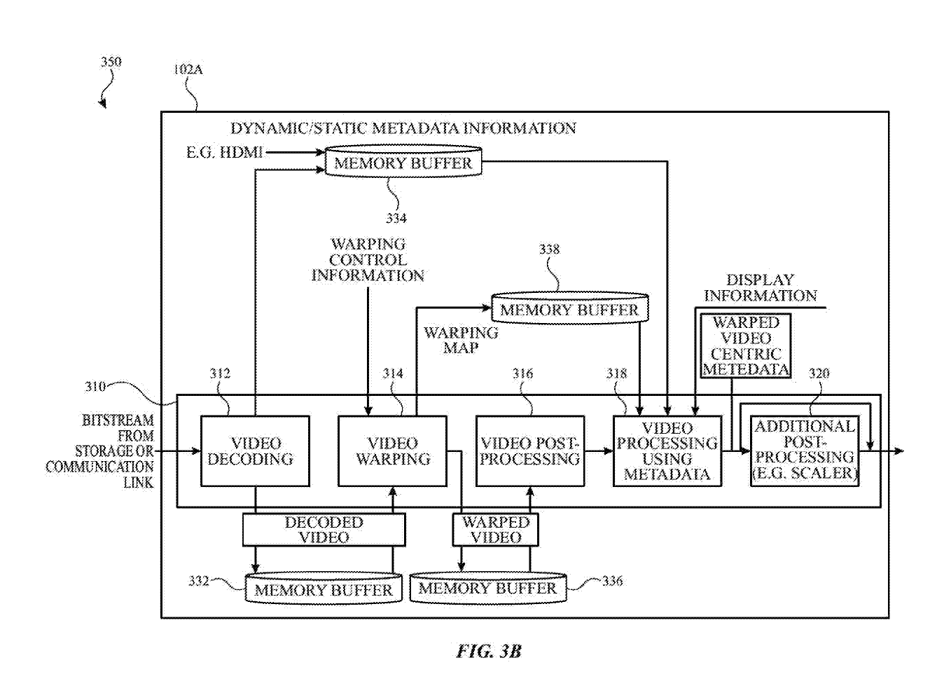

FIGS. 3A and 3B illustrate diagrams of example device architectures for metadata based quality enhancement post-video warping in accordance with one or more implementations. In particular, FIG. 3A illustrates a diagram of an example device architecture 300 for metadata based quality enhancement post-video warping in accordance with one or more implementations. FIG. 3B illustrates a diagram of an example device architecture 350 for metadata based quality enhancement post-video warping in accordance with one or more implementations, when a warping map is used. For explanatory purposes, the device architectures 300 and 350 are primarily described herein with reference to the electronic device 102A of FIGS. 1-2. However, the device architecture 300 is not limited to the electronic device 102A, and one or more blocks (or operations) of the device architectures 300 and 350 may be performed by one or more other components of the electronic device 102A. The electronic device 102A is also presented as an exemplary device and the operations described herein may be performed by any suitable device, such as one or more of the other electronic devices 102B-D of FIG. 1. Further for explanatory purposes, the blocks of the device architecture 300 are described herein as occurring in serial, or linearly. However, multiple blocks of the device architectures 300 and 350 may occur in parallel. In addition, the blocks of the device architectures 300 and 350 need not be performed in the order shown and/or one or more of the blocks of the device architectures 300 and 350 need not be performed and/or can be replaced by other operations.

In the example device architecture 300, a video warping system 310 of the electronic device 102A receives video data (e.g., via video streaming). The video warping system 310 may receive the video data from a storage unit (e.g., local storage unit 210), from a server (e.g., server 106) via a communication link, and/or from any other local or remote source. The received video data is sent to a video decoding component 312 of the electronic device 102A. The video decoding component 312 may decode the received video data if the received video data is encoded or compressed. The decoded video data may be stored in a memory buffer 332 of the electronic device 102A. The metadata associated with the video data may also be retrieved. In one example, the video decoding component 312 may extract metadata from the video data and/or the electronic device 102A may receive metadata for the video data separately from the video data (e.g., via HDMI). The metadata may be stored in a memory buffer 334 of the electronic device 102A.

A video warping component 314 receives warping control information including view configuration information and warps a subset of the decoded video data according to the view configuration information. The view configuration information may indicate one or more viewports defining one or more viewing regions. For example, the video warping component 314 may warp a subset of 360 video data that corresponds to a particular viewing direction and field of view (FOV) according to the view configuration information. The decoded video data stored at the memory buffer 332 after the video decoding may be retrieved by the video warping component 314 for warping.

For example, the view configuration information in the warping control information may include viewing direction angles indicating an angular region of the received video, field-of-view angles defining a size of portion of the received video, a video projection format, a picture resolution (e.g., a picture size) of the received video data, a bit-depth of the received video data, and a selected picture resolution of rendered video data, and a selected bit-depth of rendered video. The viewing direction angles and the field-of-view angles may be based on a user selection to view a particular viewport/viewing region. In one or more implementations, the selected picture resolution of rendered video data and the selected bit-depth of rendered video data may be determined by a user selection. The video warping component 314 may store the warped video data in a memory buffer 336.

In one example, the picture resolution of the received video data may be a 4k resolution, a bit-depth of the received video data may be 10 bits, and a selected picture resolution of rendered video data may be a 720p resolution or a 1080p resolution, a frame-rate of 60 fps, and a selected bit-depth of rendered video may be 10 bits. In such an example, a subset of the video data corresponding to a viewport indicated by the view configuration information may have the resolution of 720p or 1080p, and a frame-rate of 60 fps with the bit depth of 10 bits.

After the warping of the subset of the decoded video data by the video warping component 314, a video post-processing component 316 may perform post-processing of the warped subset of the video data. Because the post-processing is performed on the warped subset of the video data instead of the entire set of the received video data, the amount of video data being post-processed is reduced in the subject system and thus the computational resources, processing power, and time for the post-processing may be reduced. The warped subset of the video data stored at the memory buffer 336 after the video warping may be retrieved by the video post-processing component 316 for post-processing. The post-processing performed by the video post-processing component 316 may include one or more of de-noising, deringing, dithering, frame-rate conversion and picture scaling, to improve video quality for display.

After the post-processing by the video post-processing component 316, a metadata-enhancing component 318 may enhance the warped subset of the video data using metadata associated with the video data. The metadata stored in the memory buffer 334 may be retrieved by the metadata-enhancing component 318. In one or more implementations, the metadata-enhancing component 318 may also receive display information such that the metadata-enhancing component 318 may enhance the warped subset of the video data using the metadata and display information, where the display information may include one or more of a display resolution, a frame-rate, a dynamic range, and an EOTF function type. In one example, for a HDR content, the enhancement processing using metadata and display information may include color space conversion (e.g. BT.2020 to and from BT.709), EOTF conversion, dynamic luminance range adjustment, etc. Because the enhancement using the metadata is performed on the warped subset of the video data instead of the entire set of the video data, the amount of video data being post-processed is reduced in the subject system and thus the computational resources, processing power, and time for the post-processing may be reduced.

In one or more implementations, the order of the metadata-enhancing component 318 and the video post-processing component 316 may be reversed, such that the enhancement using the metadata by the metadata-enhancing component 318 may be performed before the post-processing by the video post-processing component 316. In particular, after the warping of the subset of the decoded video data by the video warping component 314, the metadata-enhancing component 318 may enhance the warped subset of the video data using the metadata associated with the video data and the display information. The warped video data stored at the memory buffer 336 after the video warping may be retrieved by the metadata-enhancing component 318 for the enhancement using the metadata. After the enhancing by the metadata-enhancing component 318, the video post-processing component 316 may perform post-processing of the warped subset of the decoded video data. The post-processing performed by the video post-processing component 316 may include one or more of de-noising, deringing, dithering, frame-rate conversion and picture scaling, to improve video quality for display.

After the post-processing by the video post-processing component 316 and the enhancement by the metadata-enhancing component 318, an additional post-processing component 320 may perform an additional processing step to the enhanced warped subset of the video data, e.g., scale the enhanced warped subset of the video data to produce the scaled video data with a resolution that matches a resolution of a display device. Subsequently, the display device displays the resulting scaled video data.

In one or more implementations, the video warping component 314 may further generate a warping map. For example, as shown in the example device architecture 350 of FIG. 3B, the video warping component 314 may generate a warping map, and may store the warping map in a memory buffer 338. The warping map indicates which data samples within video frames of the received video data are used for the warping of the subset of the video data. The warping map may be generated by recording which samples in the frames of the received video data are used when the video warping component 314 warps the subset of the video data.

In one or more implementations, the warping map may further include information about which portions of the received metadata is relevant to derivation of the warped video centric metadata which only applies to the warped video. The metadata-enhancing component 318 may derive a warped video centric metadata from the metadata based on the warping map. For example, as shown in the example device architecture 350 of FIG. 3B, the metadata-enhancing component 318 may retrieve the warping map stored in the memory buffer 338, derive the warped video centric metadata from the metadata based on the warping map, and may provide the warped video centric metadata to the additional post-processing component 320. When deriving the warped video centric metadata, the metadata-enhancing component 318 may not use a portion of the metadata corresponding to data samples that are not used for the warping of the subset of the video data. The warped video centric metadata may be provided to the additional post-processing component 320 to further improve a quality of the displayed video. The additional post-processing component 320 may process the warped video centric metadata to generate the output video metadata to provide to the display device together with the scaled video data.

In one or more implementations, the video warping component 314 may be capable of warping multiple viewports from the decoded video data. The warping of the multiple viewports may be performed on the decoded video data from the same video source. Each viewport of the multiple viewports may correspond to its own view configuration information. For example, each viewport may correspond to a different viewport and thus may have different view configuration information. When the video warping component 314 receives the warping control information with multiple sets of view configuration information for multiple viewports, the video warping component 314 may determine to warp multiple viewports from the decoded video data based on the multiple viewports indicated by the multiple sets of view configuration information. The multiple sets of view configuration information may be included in the warping control information. The metadata-enhancing component 318 may enhance the multiple viewports using metadata associated with the video data, and compose the enhanced multiple viewports into a single composed video data.

In one example, the warped subset of the video data may include the warped multiple subsets of the video data corresponding to the multiple viewports, respectively. The composed video data produced by composing the multiple subsets of the video data may collectively match the resolution of the display device. For example, if a resolution of the four subsets of the video data collectively is 1080p and thus matches the resolution of the display device that has a 1080p resolution, the additional post-processing component 320 may be skipped because scaling by the additional post-processing component 320 to fit the display device may not be necessary.

In one or more implementations, one or more of the video warping system 310, the video decoding component 312, the video warping component 314, the video post-processing component 316, the metadata-enhancing component 318, the additional post-processing component 320, and/or one or more portions thereof, may be implemented in software (e.g., subroutines and code), hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

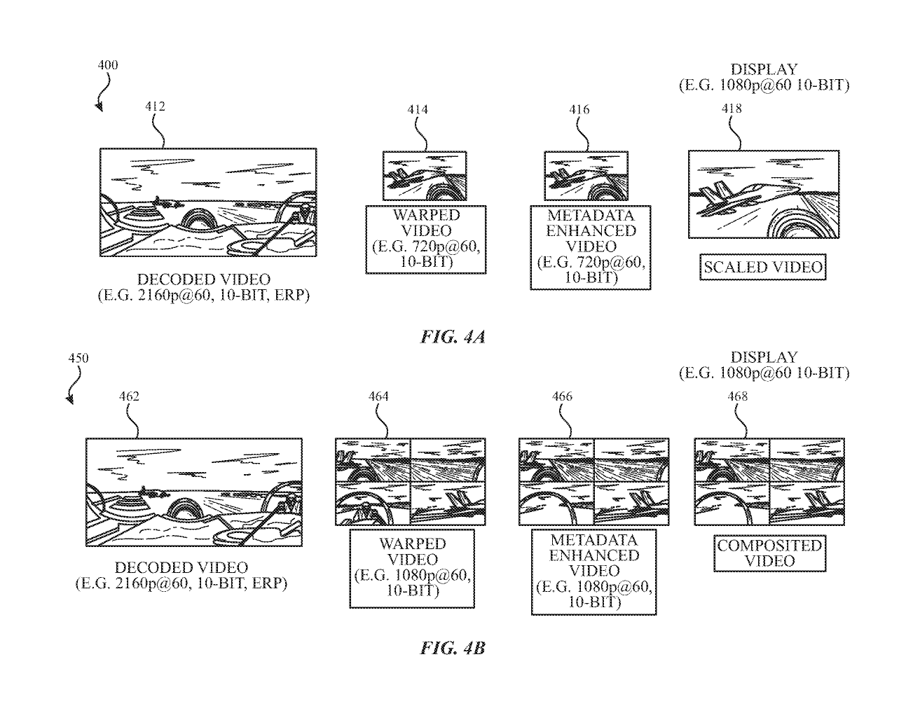

FIG. 4A is an example diagram 400 illustrating video data at various stages of the example device architecture 300 of FIG. 3A or the example device architecture 350 of FIG. 3B in accordance with one or more implementations. When the video decoding component 312 decodes the video data, the decoded video data 412 is produced. In the example diagram 400, the decoded video data 412 has a resolution of 2160p, a frame-rate of 60 fps, and a bit depth of 10 bits and is in an equirectangular projection (ERP) format. When the decoded video data is warped by the video warping component 314, the video warping component 314 may produce the warped subset 414 of the video data. In the example diagram 400, the warped subset 414 of the video data has a resolution of 720p, a frame-rate of 60 fps, and a bit depth of 10 bits. The warped subset 414 of the video data may be enhanced by the metadata-enhancing component 318 to produce the metadata-enhanced subset 416 of the video data, which may have a resolution of 720p, a frame-rate of 60 fps, and a bit depth of 10 bits.

After the enhancement by the metadata-enhancing component 318, the additional post-processing component 320 may perform scaling to produce the scaled video data 418 that fits the subset of the video data to a display device. In the example diagram 400, the subset of the video data that has been warped and enhanced with metadata is scaled from the resolution of 720p to the display device's resolution of 1080p, with a frame-rate of 60 fps, and the bit depth of 10 bits, to produce the scaled video data 418.

FIG. 4B is an example diagram 450 illustrating video data at various stages of the example device architecture 300 of FIG. 3A or the example device architecture 350 of FIG. 3B in accordance with one or more implementations. When the video decoding component 312 decodes the video data, the decoded video data 462 is produced. In the example diagram 450, the decoded video data 462 has a resolution of 2160p, a frame-rate of 60 fps, and a bit depth of 10 bits and is in an ERP format. If the video warping component 314 warps multiple viewports from the decoded video data, the video warping component 314 may produce the warped subset 464 of the video data in multiple viewports. In the example diagram 400, the warped subset 464 of the video data includes four viewports, with a combined resolution of 1080p, a frame-rate of 60 fps, and a bit depth of 10 bits. The warped subset 464 of the video data may be enhanced by the metadata-enhancing component 318 to produce the metadata-enhanced subset 466 of the video data including four viewports. The metadata-enhancing component 318 may further compose the metadata-enhanced viewports 466 into a single composed video data 468 which may have a combined resolution of 1080, a frame-rate of 60 fps, and a bit depth of 10 bits.

After the processing by the metadata-enhancing component 318, the additional post-processing component 320 may perform scaling to fit the composed video data 468 to a display device. For example, the scaling may be skipped if the composed video data 468 has the resolution of 1080p that is the same as the resolution of 1080p of the display device, with the bit depth of 10 bits. Thus, the display device may display the composed video data 468 with four viewports.

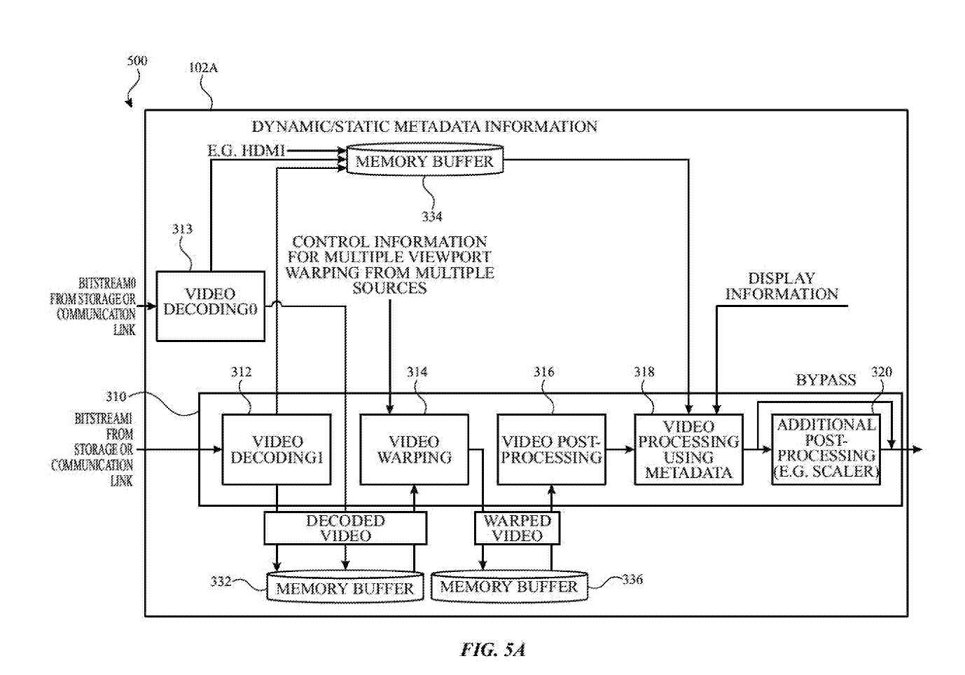

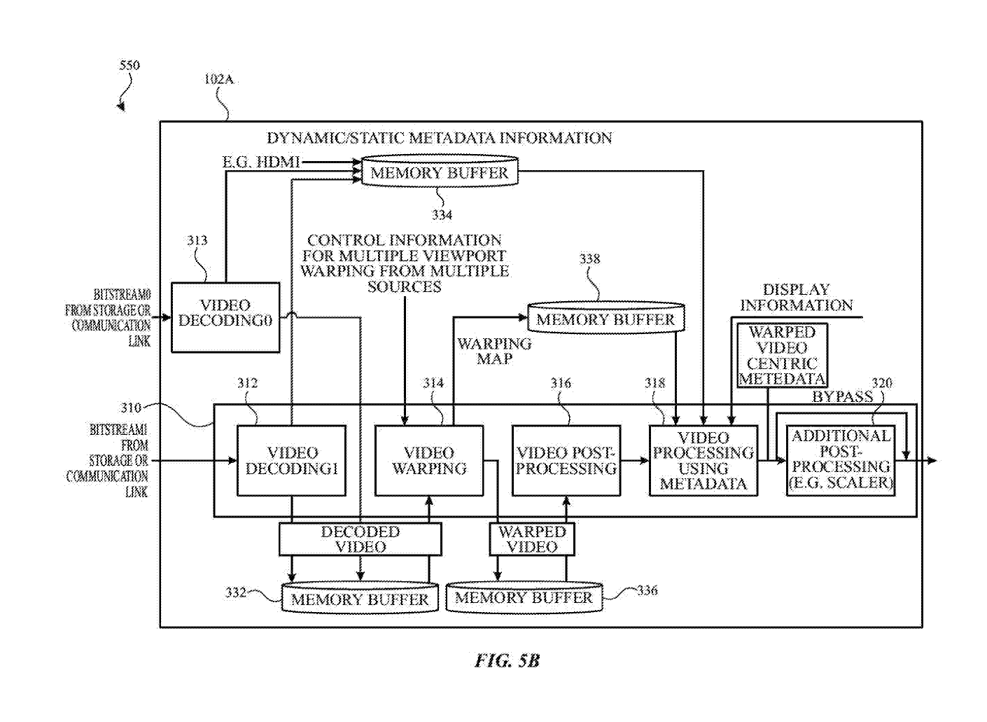

FIGS. 5A and 5B illustrate diagrams of example device architectures for metadata based quality enhancement post-video warping in accordance with one or more implementations In particular, FIG. 5A illustrates a diagram of an example device architecture 500 for metadata based quality enhancement post video-warping in accordance with one or more implementations. FIG. 5B illustrates a diagram of an example device architecture 550 for metadata based quality enhancement post-video warping in accordance with one or more implementations, when a warping map is used. For explanatory purposes, the device architectures 500 and 550 are primarily described herein with reference to the electronic device 102A of FIGS. 1-2. However, the device architectures 500 and 550 are not limited to the electronic device 102A, and one or more blocks (or operations) of the device architectures 500 and 550 may be performed by one or more other components of the electronic device 102A. The electronic device 102A is also presented as an exemplary device and the operations described herein may be performed by any suitable device, such as one or more of the other electronic devices 102B-D of FIG. 1. Further for explanatory purposes, the blocks of the device architecture 500 are described herein as occurring in serial, or linearly. However, multiple blocks of the device architectures 500 and 550 may occur in parallel. In addition, the blocks of the device architectures 500 and 550 need not be performed in the order shown and/or one or more of the blocks of the device architectures 500 and 550 need not be performed and/or can be replaced by other operations.

In the example device architecture 500, the video warping system 310 may receive multiple video data from multiple video sources. The multiple video data may have the same format or may have different formats. In one example, one video source may provide video data in a 360 video cube map projection (CMP) format, and another video source may provide video data in a 360 video equirectangular projection (ERP) format. In another example, one video source may provide 360 video data, and another video source may provide non-360 video data (e.g., 2D conventional video data). The multiple video data may also have different contents. The video sources may include one or more of a storage unit (e.g., local storage unit 210) and/or from a server (e.g., server 106). The multiple video sources may exist within a same storage unit or within a same server. In the example device architecture 500, the video warping system 310 receives two separate video data from two video sources that are received. When the first video data from the first video source is received, the first video data may be sent to a video decoding component 312, and the second video data may be sent to a second video decoding component 313. The video decoding component 312 decodes the first video data and may store the decoded first video data in the memory buffer 332. The second video decoding component 313 decodes the second video data and may store the decoded second video data in the memory buffer 332.

The first metadata associated with the first video data and the second metadata associated with the second video data may be retrieved. In one example, the video decoding component 312 may extract the first metadata from the first video data and/or the second video decoding component 313 may extract the second metadata from the second video data. In one example, the electronic device 102A may receive the first metadata for the first video data separately from the first video data (e.g., via HDMI) and/or may receive the second metadata for the second video data separately from the second video data (e.g., via HDMI). The first metadata and the second metadata may be stored in the memory buffer 334. In another example, the second video data may not be associated with metadata, and thus no metadata may be retrieved for the second video data.

The video warping component 314 receives first warping control information including first view configuration information for the first video data and second warping control information including second view configuration information for the second video data, and warps a subset of the decoded first video data and a subset of the decoded second video data according to the first view configuration information and the second view configuration information, respectively. The decoded first video data and the decoded second video data stored at the memory buffer 332 after the video decoding may be retrieved by the video warping component 314 for warping. The first warping control information may include first view configuration information for a single viewport or may include multiple sets of first view configuration information for multiple viewports for the first video data. The second warping control information may include second view configuration information for a single viewport or may include multiple sets of second view configuration information for multiple viewports for the second video data. The video warping component 314 may store the warped subset of the first video data and the warped subset of the second video data in the memory buffer 336.

As discussed above, each set of view configuration information may indicate one or more viewports defining one or more viewing regions. For example, each warping control information may include viewing direction angles indicating an angular region of the received video, field-of-view angles defining a size of portion of the received video, a video projection format, a picture resolution of the received video data, a bit-depth of the received video data, and a selected picture resolution of rendered video data, and a selected bit-depth of rendered video. The viewing direction angles and the field-of-view angles may be based on a user selection to view a particular viewing region. The selected picture resolution of rendered video data and the selected bit-depth of rendered video data may be defined by a user selection.

If the first warping control information includes the first view configuration information corresponding to a single viewport, the video warping component 314 may warp the subset of the decoded first video data for a single viewport based on the single viewport indicated by the view configuration information. If the first warping control information includes multiple sets of the first view configuration information corresponding to multiple viewports, the video warping component 314 may warp the subset of the decoded first video data for the multiple viewports based on the multiple viewports indicated by the multiple sets of the first view configuration information. If the second warping control information includes the second view configuration information corresponding to a single viewport, the video warping component 314 may warp the subset of the decoded second video data for a single viewport based on the single viewport indicated by the view configuration information. If the second warping control information includes multiple sets of the second view configuration information corresponding to multiple viewports, the video warping component 314 may warp the subset of the decoded second video data for the multiple viewports based on the multiple viewports indicated by the multiple sets of the second view configuration information.

After the warping by the video warping component 314, the video post-processing component 316 may perform post-processing of the warped subset of the first video data and the warped subset of the second video data. The warped subset of the first video data and the warped subset of the second video data stored at the memory buffer 336 after the video warping may be retrieved by the video post-processing component 316 for post-processing. The post-processing performed by the video post-processing component 316 may include one or more of de-noising, deringing, dithering, frame-rate conversion and picture scaling, to improve video quality for display. Because the post-processing is performed on the warped subset of the first video data and the warped subset of the second video data instead of the entire set of the first and second video data, the amount of data being post-processed is reduced in the subject system and thus the computation resources, processing power, and time for the post-processing may be reduced.

After the post-processing by the video post-processing component 316, the metadata-enhancing component 318 may enhance the warped subset of the first video data using the first metadata associated with the first video data and/or may enhance the warped subset of the second video data using the second metadata associated with the second video data. The first metadata and/or the second metadata stored in the memory buffer 334 may be retrieved by the metadata-enhancing component 318. Because the enhancement using the first and second metadata is performed on the warped subset of the first video data and the warped subset of the second video data instead of the entire set of the first and second video data, the amount of data being processed is reduced in the subject system and thus the computation resources, processing power, and time for the post-processing may be reduced.

In some cases, the first video data or the second video data may not be associated with metadata. For example, the first video data may be associated with the first metadata that is stored in the memory buffer 334 but the second video data may not be associated with metadata. In such an example, the metadata-enhancing component 318 may enhance the warped subset of the first video data using the first metadata, but may skip enhancing the warped subset of the second video data that is not associated with metadata.

In one or more implementations, the metadata-enhancing component 318 also receive display information, where the display information may include one or more of a display resolution, a frame-rate, a dynamic range, and an EOTF function type. In particular, the metadata-enhancing component 318 may enhance the warped subset of the first video data using the first metadata and first display information (e.g., if the first metadata associated with the first video data exists). The metadata-enhancing component 318 may enhance the warped subset of the second video data using the second metadata and second display information (e.g., if the second metadata associated with the second video data exists).

In one or more implementations, after the enhancement using associated metadata and display information, the metadata-enhancing component 318 may further compose the warped subset of the first video data and the warped subset of the second video data into a single composed video data.

In one or more implementations, the order of the metadata-enhancing component 318 and the video post-processing component 316 may be reversed, such that the processing by the metadata-enhancing component 318 may be performed before the post-processing by the video post-processing component 316. In particular, after the warping of the subset of the decoded first video data and the subset of the decoded second video data by the video warping component 314, the metadata-enhancing component 318 may enhance the warped subset of the first video data using the first metadata associated with the first video data, and may enhance the warped subset of the second video data using the second metadata associated with the second video data. The warped subset of the first video data and the warped subset of the second video data stored at the memory buffer 336 after the video warping may be retrieved by the metadata-enhancing component 318 for enhancement using the first and second metadata and for composing the enhanced warped subset of the first video data and the enhanced warped subset of the second video data into a single composed video data. After the processing by the metadata-enhancing component 318, the video post-processing component 316 may perform post-processing of the composed video data.

After the post-processing by the video post-processing component 316 and the processing by the metadata-enhancing component 318, an additional post-processing component 320 may perform an additional processing step on the composed video data, e.g., scale the composed video data to a resolution that matches a resolution of a display device. Subsequently, the display device displays the scaled video data.

In one or more implementations, the video warping component 314 may further generate warping maps, where each warping map is generated for a respective viewport of multiple viewports from multiple video data. For example, as shown in the example device architecture 550 of FIG. 5B, the video warping component 314 may generate one or more first warping maps for the first video data and one or more second warping maps for the second video data, and may store the warping maps in a memory buffer 338. Each warping map indicates the data samples within video frames of corresponding received video data that are used for the warping of the subset of the corresponding video data. Each warping map may be generated by recording which samples in the frames of the received video data are used when the video warping component 314 warps the subset of the corresponding video data.

In one or more implementations, each warping map may further include information about which portions of the received metadata is relevant to derivation of the warped video centric metadata which only applies to the warped video. The metadata-enhancing component 318 may derive a warped video centric metadata from the metadata based on the warping maps. For example, as shown in the example device architecture 550 of FIG. 5B, the metadata-enhancing component 318 may retrieve the warping maps stored in the memory buffer 338, derive the warped video centric metadata from the metadata based on the warping maps, and may provide the warped video centric metadata to the additional post-processing component 320. When deriving the warped video centric metadata, the metadata-enhancing component 318 may not use data samples that are not used for the warping of the subset of the video data. The warped video centric metadata may be provided to the additional post-processing component 320 to further improve a quality of the displayed video. The additional post-processing component 320 may process the warped video centric metadata to generate an output video metadata to provide to the display device together with the scaled video data.

In one or more implementations, a video warping system may support stereoscopic video warping, where the warping is performed for two viewports, a first viewport for a left-eye view and a second viewport for a right-eye view. In such a stereoscopic video warping system, the video warping component 314 performs the video warping before the metadata-enhancing component 318 performs stereoscopic processing to enhance using metadata, so as to minimize both the memory bandwidth consumption and usage of computational resources. The video warping component 314 may also generate warping maps to indicate which data samples in the received stereoscopic video data are used for warping the first and second viewport. The metadata-enhancing component 318 may create a stereoscopic viewports centric metadata based on warping maps for the first viewport and the second viewport, such that the additional post-processing component 320 and/or the display device may scale and display the first viewport and the second viewport based on the stereoscopic viewports centric metadata.

In one example, for 360 video applications, video data for the first viewport corresponding to the left view and video data for the second viewport corresponding to the right view may be in the same projection format (e.g. ERP) or in different projection formats, and may have the same or different video fidelity. The video data for the first viewport and the video data for the second viewport may be received from the same video source or may be received from two respective video sources. When the video data for the first viewport and the second viewport are received from the same video source, the first and second subsets of the video data corresponding to the first and second viewports may be warped from a single stereoscopic video source. The video data from the single stereoscopic video source may be frame-packed side-by-side (e.g., at a left side and a right side) or at the top and the bottom, or the video data corresponding to the left and right views may be interleaved frame-by-frame. The stereoscopic viewports may be warped from two video sources, in which the left view and right view of a stereoscopic video source may be compressed and transmitted as first video data and second video data (e.g., in two separate bitstreams). The dynamic/static metadata (e.g. HDR metadata) for stereoscopic video may be the same or different for the left view and the right view.

In one or more implementations, one or more of the video warping system 310, the first video decoding component 312, the second video decoding component 313, the video warping component 314, the video post-processing component 316, the metadata-enhancing component 318, the additional post-processing component 320, and/or one or more portions thereof, may be implemented in software (e.g., subroutines and code), hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

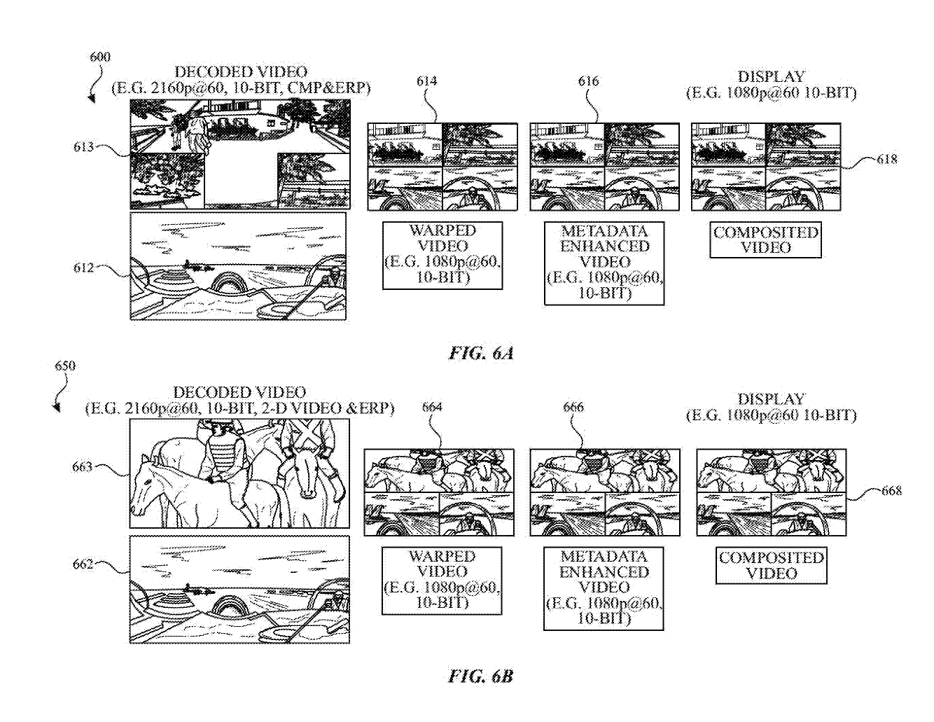

FIG. 6A is an example diagram 600 illustrating video data at various stages of the example device architecture 500 of FIG. 5A or the example device architecture 550 of FIG. 5B in accordance with one or more implementations. When the video decoding component 312 decodes the first video data from a first video source, the decoded first video data 612 is produced. When the second video decoding component 313 decodes the second video data from a second video source, the decoded second video data 613 is produced. In the example diagram 600, both the decoded first video data 612, and the decoded second video data 613 have a resolution of 2160p, a frame-rate 60 fps and a bit depth of 10 bits. The decoded first video data 612 is in an ERP format and the decoded second video data 613 is in a CMP format.

When the decoded first video data and the decoded second video data are warped by the video warping component 314, the video warping component 314 may produce the warped subset 614 of the video data, wherein the warped subset 614 has multiple viewports from the decoded first video data and the decoded second video data. In particular, the warped subset 614 includes two viewports from the decoded second video data on top and two viewports from the decoded first video data at the bottom of the warped subset 614. In the example diagram 600, the warped subset 614 of the video data has a combined resolution of 1080p, a frame-rate of 60 fps, and a bit depth of 10 bits. The warped subset 614 of the video data may be enhanced by the metadata-enhancing component 318 to produce the metadata-enhanced subset 616 of the video data, which may include two viewports from the decoded second video data on top and two viewports from the decoded first video data at the bottom of the warped subset 614. In the example diagram 600, the metadata-enhanced subset 614 of the video data has a combined resolution of 1080p, a frame-rate of 60 fps, and a bit depth of 10 bits. The metadata-enhanced subset 616 of the video data corresponding to two viewports from the decoded second video data and two viewports from the decoded first video data may further be composed by the metadata-enhancing component 318 to produce a single composed video data.

After processing by the metadata-enhancing component 318, the additional post-processing component 320 may perform scaling to fit the composed video data to a display device. In the example diagram 600, the scaling may be skipped because the combined resolution of 1080p for the composed video data is the same as the display device's resolution of 1080p, with the bit depth of 10 bits. Thus, the display device displays the composed video data 618 with two viewports from the first video data and two viewports from the second video data.

FIG. 6B is an example diagram 650 illustrating video data at various stages of the example device architecture 500 of FIG. 5A or the example device architecture 550 of FIG. 5B in accordance with one or more implementations. When the video decoding component 312 decodes the first video data from a first video source, the decoded first video data 662 is produced. When the second video decoding component 313 decodes the second video data from a second video source, the decoded second video data 663 is produced. In the example diagram 600, both the decoded first video data 662 and the decoded second video data 663 have a resolution of 2160p, a frame-rate of 60 fps, and a bit depth of 10 bits. The decoded first video data 662 is in an ERP format and the decoded second video data 663 is in a 2D conventional video format.

When the decoded first video data and the decoded second video data are warped by the video warping component 314, the video warping component 314 may produce the warped subset 664 of the video data, wherein the warped subset 664 has multiple viewports from the decoded first video data and the decoded second video data. In particular, the warped subset 664 includes one viewport from the decoded second video data on top and two viewports from the decoded first video data at the bottom of the warped subset 664. In the example diagram 600, the warped subset 664 of the video data has a combined resolution of 1080p, a frame-rate of 60 fps, and a bit depth of 10 bits. The warped subset 664 of the video data may be enhanced by the metadata-enhancing component 318 to produce the metadata-enhanced subset 666 of the video data, which may include one viewport from the decoded second video data on top and two viewports from the decoded first video data at the bottom of the warped subset 664. In the example diagram 600, the metadata-enhanced subset 664 of the video data has a combined resolution of 1080p, a frame-rate of 60 fps, and a bit depth of 10 bits. The metadata-enhanced subset 664 of the video data corresponding to one viewport from the decoded second video data and two viewports from the decoded first video data may further be composed by the metadata-enhancing component 318 to produce a single composed video data.

In the example diagram 600, the decoded second video data 663 is in a 2D conventional video format, the video warping component 314 may perform video cropping and/or scaling to produce the viewport from the from the decoded second video data. The metadata-enhancing component 318 may skip the metadata enhancement on the viewport of the decoded second video data if there is no metadata associated with it.

After the processing by the metadata-enhancing component 318, the additional post-processing component 320 may perform scaling to fit the composed video data to a display device. In In the example diagram 600, the scaling may be skipped because the combined resolution of 1080p for the composed video data is the same as the display device's resolution of 1080p, with the bit depth of 10 bits. Thus, the display device displays the composed video data 668 with two viewports from the first video data and one viewport from the second video data.

FIGS. 7-9 illustrate a flow diagram of example processes 700-900 of metadata based quality enhancement post-video warping in accordance with one or more implementations. For explanatory purposes, the processes 700-900 are primarily described herein with reference to electronic device 102A of FIGS. 1-2. However, the processes 700-900 are not limited to the electronic device 102A, and one or more blocks (or operations) of the processes 700-900 may be performed by one or more other components of the electronic device 102A. The electronic device 102A also is presented as an exemplary device and the operations described herein may be performed by any suitable device, such as one or more of the other electronic devices 102B-D. Further for explanatory purposes, the blocks of the processes 700-900 are described herein as occurring in serial, or linearly. However, multiple blocks of the processes 700-900 may occur in parallel. In addition, the blocks of the processes 700-900 need not be performed in the order shown and/or one or more of the blocks of the processes 700-900 need not be performed and/or can be replaced by other operations.

FIG. 7 illustrates a flow diagram of an example process 700 of metadata based quality enhancement post-video warping in accordance with one or more implementations. Each block in the process 700 may be performed by a processor 202 or another component of the electronic device 102A, such as a video decoding circuitry, a video processing circuitry, or other dedicated circuitry for a particular operation of each block. In the process 700, the processor 202 (or other component) of the electronic device 102A may receive video data (e.g., via the communication interface 206) (702). When the processor 202 receives the video data, the processor 202 may decode the video data. The processor 202 receives (e.g., via the communication interface 206 and/or via user input at the electronic device 102A) or generates control information (e.g., warping control information) including view configuration information (702). The processor 202 warps a subset of the video data according to the view configuration information (704). The subset of the video data is less than an entirety of the video data. The view configuration information may include view configuration information for one or more viewports, and the subset of the video data may include one or more portions of the video data corresponding to the one or more viewports, respectively.

The processor 202 may generate a warping map indicating data samples within frames of the video data used for the warping of the subset of the video data (706). The warping map may be generated during the warping of the subset of the video data. For example, the warping map may be generated by recording which samples in the frames of the video data are used when the processor 202 warps the subset of the video data.

The processor 202 may perform post-processing of the warped subset of the video data (710). The processor 202 may perform the post-processing by performing at least one of de-noising, deringing, dithering, frame-rate conversion, or picture scaling. The warped subset of the video data may be processed using the metadata associated with the video data before or after the post-processing. As discussed above, because the post-processing is performed on the warped subset of the video data instead of the entire set of the video data, the amount of video data being post-processed is reduced in the subject system and thus the computational resources, processing power, and time for the post-processing may be reduced.

The processor 202 processes the warped subset of the video data using metadata associated with the video data (712). The metadata may include at least one of a source frame specification of primary color space, an EOTF type, a peak luminance level, an average luminance level, or an algorithm to restore an original pixel precision. As discussed above, because the processing using the metadata is performed on the warped subset of the video data instead of the entire set of the video data, the amount of video data being processed is reduced in the subject system and thus the computational resources, processing power, and time for the post-processing may be reduced.

The processor 202 derives a warped video centric metadata based on the warping map and the metadata associated with the video data (714). The warping map may further indicate a subset of metadata corresponding to the subset of the video data. The warped video centric metadata may be derived from the subset of the metadata. The warped video centric metadata may be used by additional post-processing and/or processing for a display device to further improve the display view quality of the warped subset of the video data. The warped video centric metadata may also be processed to generate an output video metadata for sending to the display device. The processor 202 may perform additional post processing. For example, the processor 202 may perform video scaling processing of the processed warped subset of the video data (e.g., to produce scaled video data that matches the display device) (716). The processor 202 may process warped video centric metadata to generate output video metadata (718). The processor 202 provides, for display, the processed warped subset of the video data (e.g., the scaled video data) and the output video metadata (e.g., using the display component 208 of the electronic device 102A) (720).

The subset of the video data may include a first portion and a second portion of the video data, the first portion corresponding to a viewing direction angle and an FOV angle for left-eye viewing and the second portion corresponding to a viewing direction angle and an FOV angle for right-eye viewing. For example, for stereoscopic video warping, one portion from the first video source may be warped for the left-eye viewing and another portion from the second video source may be warped for the right-eye viewing.

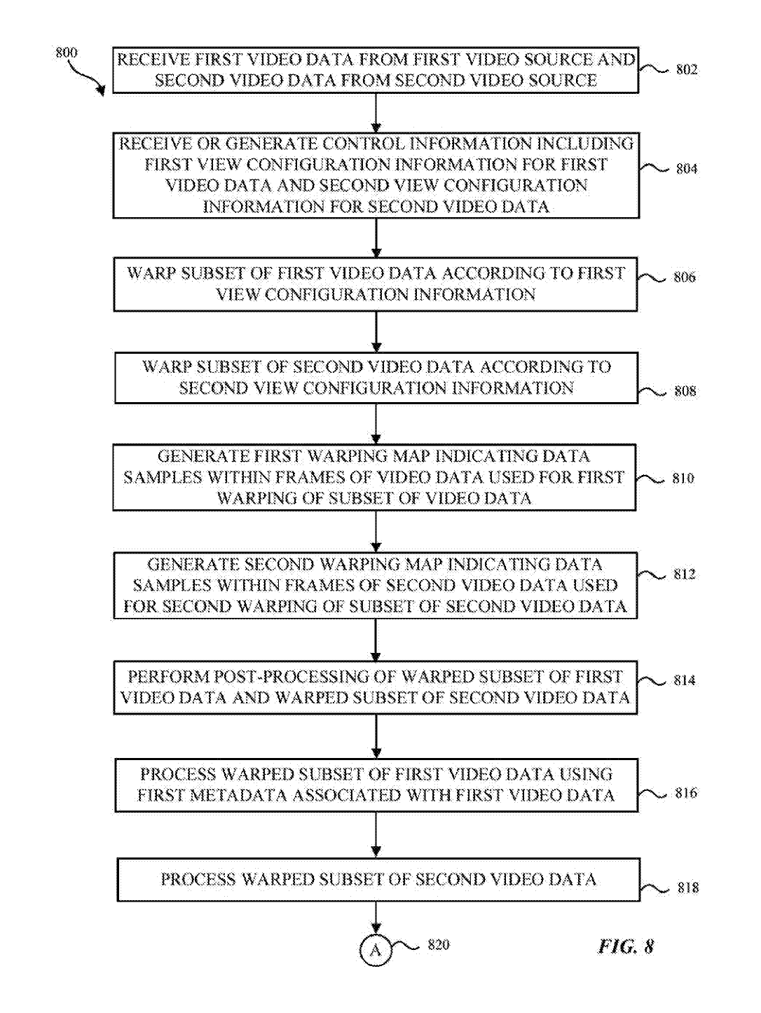

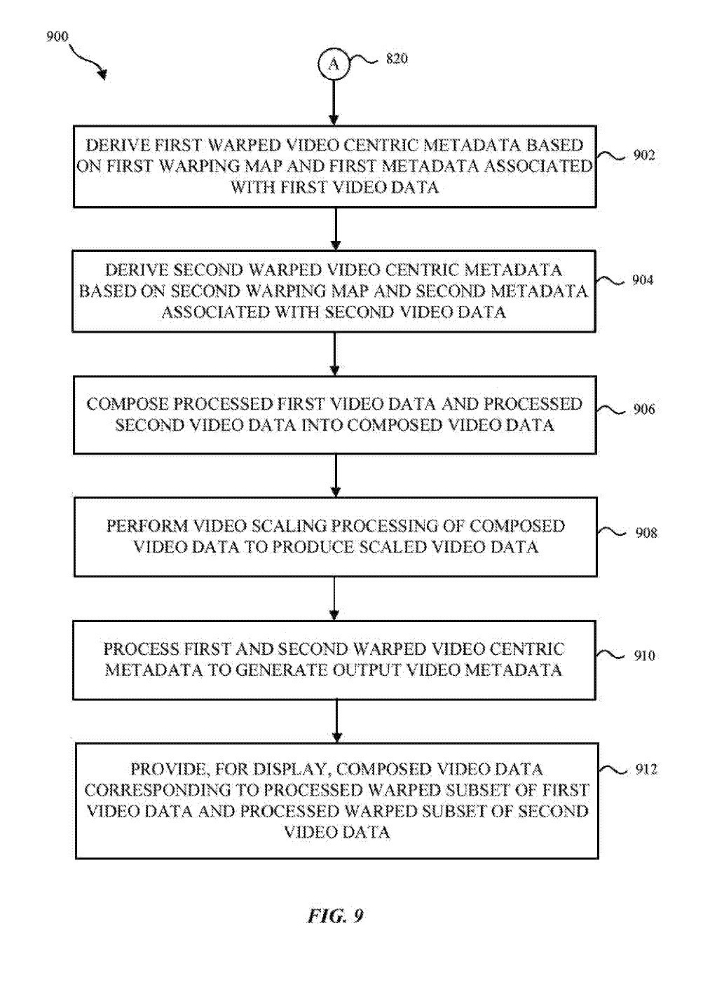

FIG. 8 illustrates a flow diagram of an example process 800 of metadata based quality enhancement post-video warping in accordance with one or more implementations. Each block in the process 800 may be performed by a processor 202 or another component of the electronic device 102A, such as a video decoding circuitry, a video processing circuitry, or other dedicated circuitry for a particular operation of each block. In the process 800, the processor 202 of the electronic device 102A receives first video data from a first video source and second video data from a second video source (e.g., via the communication interface 206) (802). When the processor 202 receives the first and second video data, the processor 202 may decode the first and second video data. The processor 202 receives (e.g., via the communication interface 206 and/or via user input at the electronic device 102A) or generates control information (e.g., warping control information) including first view configuration information for the first video data and second view configuration information for second video data (804). The processor 202 warps a subset of the first video data according to the first view configuration information (806). The processor 202 warps a second of the first video data according to the second view configuration information (808). The subset of the first video data is less than an entirety of the first video data, and the subset of the second video data is less than an entirety of the second video data. The first view configuration information may include view configuration information for one or more first viewports and the subset of the first video data may include one or more portions of the first video data corresponding to the one or more first viewports, respectively. The second view configuration information may include view configuration information for one or more second viewports, and the subset of the second video data may include one or more portions of the second video data corresponding to the one or more second viewports, respectively.

The processor 202 may generate a first warping map indicating data samples within frames of the first video data used for the warping of the subset of the first video data (810). The first warping map may be generated during the warping of the subset of the first video data. The processor 202 may generate a second warping map indicating data samples within frames of the second video data used for the warping of the subset of the second video data (812). The second warping map may be generated during the warping of the subset of the second video data.

The processor 202 may perform post-processing of the warped subset of the first video data and the warped subset of the second video data (814). The processor 202 may perform the post-processing by performing at least one of de-noising, deringing, dithering, frame-rate conversion, or picture scaling. The warped subset of the first video data may be processed using the metadata associated with the first video data before or after the post-processing. The warped subset of the second video data may be processed (e.g., using the second metadata associated with the second video data) before or after the post-processing. As discussed above, because the post-processing is performed on the warped subset of the first video data and the warped subset of the second video data instead of the entire set of the first and second video data, the amount of data being post-processed is reduced in the subject system and thus the computational resources, processing power, and time for the post-processing may be reduced.

The processor 202 processes the warped subset of the first video data using first metadata associated with the first video data to produce the processed first video data (816). The first metadata may include at least one of a source frame specification of primary color space, a peak, an average luminance level, or an algorithm to restore an original pixel precision. The processor 202 processes the warped subset of the second video data to produce the processed second video data (818). When the second video data carries second metadata for the second video, the warped subset of the second video data may be processed using the second metadata. When the second video does not carry second metadata for the second video, the warped subset of the second video data may be processed without using the second metadata. As discussed above, because the processing using the first and second metadata is performed on the warped subset of the first video data and the warped subset of the second video data, instead of the entire set of the first and second video data, the amount of data being processed is reduced in the subject system and thus the computational resources, processing power, and time for the post-processing may be reduced.

The processor 202 may perform additional features (820), as discussed below.

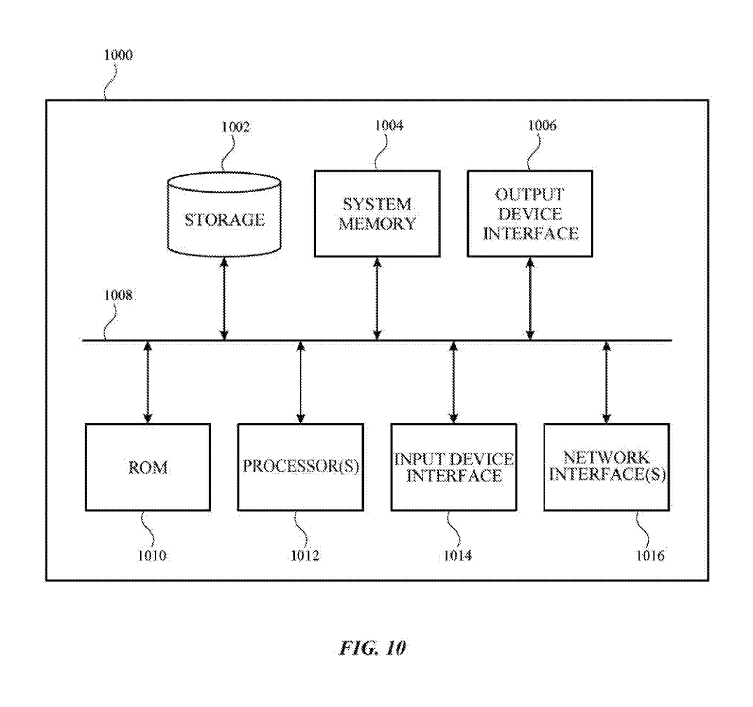

FIG. 9 illustrates a flow diagram of an example process 900 of metadata based quality enhancement post-video warping in accordance with one or more implementations, continuing from the example process 800 of FIG. 8.

The processor 202 derives a first warped video centric metadata based on the first warping map and the first metadata associated with the first video data (902). The first warping map may further indicate a subset of first metadata corresponding to the subset of the first video data. The first warped video centric metadata may be derived from the subset of the first metadata. The processor 202 derives a second warped video centric metadata based on the second warping map and the second metadata associated with the second video data (904). The second warping map may further indicate a subset of second metadata corresponding to the subset of the second video data. The second warped video centric metadata may be derived from the subset of the second metadata.

The processor 202 composes the processed warped subset of the first video data and the processed warped subset of the second video data into composed video data (906). For example, as discussed above, the processed first video data and the processed second video data may be composed into a single composed video data. The processor 202 may perform additional post processing. For example, the processor 202 may perform video scaling processing of the composed video data to produce scaled video data (908). As discussed above, the first warped video centric metadata and the second warped video centric metadata may be used to further improve a quality of the displayed video by additional post-processing and/or by display devices. The processor 202 processes the first warped video centric metadata and the second warped video centric metadata to generate output video metadata (910). The processor 202 provides, for display, the composed video data (e.g., the scaled video data) corresponding to the processed first video data and the processed second video data and the output video metadata (e.g., using the display component 208 of the electronic device 102A) (912).

The subset of the video data may include a first portion and a second portion of the video data, the first portion corresponding to a viewing direction angle and an FOV angle for left-eye viewing and the second portion corresponding to a viewing direction angle and an FOV angle for right-eye viewing. For example, for stereoscopic video warping, the first video data from the first video source may be warped for the left-eye viewing and the second video data from the second video source may be warped for the right-eye viewing.

FIG. 10 illustrates an electronic system 1000 with which one or more implementations of the subject technology may be implemented. The electronic system 1000 can be, and/or can be a part of, one or more of the electronic devices 102A-C shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010. From these various memory units, the one or more processing unit(s) 1012 retrieves instructions to execute and data to process in order to execute the processes of one or more implementations.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying,” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device, comprising:
at least one processor configured to:
receive or generate control information including view configuration information;
warp a subset of video data according to the view configuration information;
process the warped subset of the video data using metadata associated with the video data; and
provide, for display, the processed warped subset of the video data.

2. The device of claim 1, wherein the subset of the video data is less than an entirety of the video data.

3. The device of claim 1, wherein the metadata includes at least one of a source frame specification of primary color space, an electro-optical transfer function (EOTF) function type, a peak luminance level, an average luminance level, or an algorithm to restore an original pixel precision.

4. The device of claim 1, wherein the at least one processor is further configured to:
generate a warping map indicating data samples within frames of the video data used for the warping of the subset of the video data.

5. The device of claim 4, wherein the at least one processor is further configured to:
derive a warped video centric metadata based on the warping map and the metadata associated with the video data;
perform video scaling processing of the processed warped subset of the video data to produce scaled video data; and
process the warped video centric metadata to generate output video metadata,
wherein the processed warped subset of the video data is provided for display by providing the scaled video data and the output video metadata for display.

6. The device of claim 5, wherein the warping map further indicates a subset of metadata corresponding to the subset of the video data, and
wherein the warped video centric metadata is derived from the subset of the metadata.

7. The device of claim 1, wherein the view configuration information includes view configuration information for one or more viewports, and
the subset of the video data includes one or more portions of the video data corresponding to the one or more viewports, respectively.

8. The device of claim 1, wherein the at least one processor is further configured to:
perform post-processing of the warped subset of the video data,
wherein the warped subset of the video data is processed using the metadata associated with the video data before or after the post-processing.

9. The device of claim 8, wherein the post-processing is performed by performing at least one of de-noising, deringing, dithering, frame-rate conversion, or picture scaling.

10. The device of claim 1, wherein the subset of the video data includes a first portion and a second portion of the video data, the first portion corresponding to a viewing direction angle and a field of view (FOV) angle for left-eye viewing and the second portion corresponding to a viewing direction angle and an FOV angle for right-eye viewing.

11. A method performed by a device, comprising:
receiving first video data from a first video source and second video data from a second video source;
receiving or generating control information including first view configuration information for the first video data and second view configuration information for second video data;
warping a subset of the first video data according to the first view configuration information;
warping a subset of the second video data according to the second view configuration information;
processing the warped subset of the first video data using first metadata associated with the first video data to produce processed first video data;
processing the warped subset of the second video data using second metadata associated with the second video data to produce processed second video data;
generating a first warping map indicating data samples within frames of the first video data used for the warping of the subset of the first video data;
generating a second warping map indicating data samples within frames of the second video data used for the warping of the subset of the second video data;
deriving a first warped video centric metadata based on the first warping map and the first metadata associated with the first video data;
deriving a second warped video centric metadata based on the second warping map and the second metadata associated with the second video data;
composing the processed first video data and the processed second video data into composed video data;
performing video scaling processing of the composed video data to produce scaled video data;
processing the first and second warped video centric metadata to generate output video metadata;
providing, for display, the scaled video data corresponding to the processed first video data and the processed second video data and the output video metadata generated from the first and second warped video centric metadata.

12. The method of claim 11, wherein when the second video data carries second metadata for the second video, the warped subset of the second video data is processed using the second metadata, and
when the second video does not carry second metadata for the second video, the warped subset of the second video data is processed without using the second metadata.

13. The method of claim 11, wherein the first view configuration information includes view configuration information for one or more first viewports, and the subset of the first video data includes one or more portions of the first video data corresponding to the one or more first viewports, respectively, and
wherein the second view configuration information includes view configuration information for one or more second viewports, and the subset of the second video data includes one or more portions of the second video data corresponding to the one or more second viewports, respectively.

14. The method of claim 11, further comprising:
performing post-processing of the warped subset of the first video data and the warped subset of the second video data,
wherein the warped subset of the first video data is processed using the first metadata associated with the first video data and the warped subset of the second video data is processed before or after the post-processing.

15. The method of claim 11, wherein the subset of the first video data corresponds to a viewing direction angle and a field of view (FOV) angle for left-eye viewing and the subset of the second video data corresponds to a viewing direction angle and an FOV angle for right-eye viewing.

16. A non-transitory, processor-readable storage media encoded with instructions that, when executed by processor, cause the processor to perform a method comprising:
receiving or generating control information including view configuration information;
warping a subset of video data according to the view configuration information;
processing the warped subset of the video data using metadata associated with the video data; and
providing, for display, the processed warped subset of the video data.

17. The processor-readable storage media of claim 16, wherein the method further comprises:
generating a warping map indicating data samples within frames of the video data used for the warping of the subset of the video data.

18. The processor-readable storage media of claim 17, wherein the method further comprises:
deriving a warped video centric metadata based on the warping map and the metadata associated with the video data;
performing video scaling processing of the processed warped subset of the video data to produce scaled video data; and
processing the warped video centric metadata to generate output video metadata,
wherein providing the processed warped subset of the video data for display comprises providing the scaled video data and the output video metadata for display.

19. The processor-readable storage media of claim 16, wherein the method further comprises:
performing post-processing of the warped subset of the video data,
wherein the warped subset of the video data is processed using the metadata associated with the video data before or after the post-processing.

20. The processor-readable storage media of claim 16, wherein the subset of the video data includes a first portion and a second portion of the video data, the first portion corresponding to a viewing direction and an FOV angle for left-eye viewing and the second portion corresponding to a viewing direction and an FOV angle for right-eye viewing.
